(19) United States
(12) Patent Application Publication
(10) Pub. No.: US 2024/0192665 A1
(43) Pub. Date: Jun. 13, 2024

(54) OPTIMIZATION METHOD FOR OPERATING PLANTS IN THE PRIMARY INDUSTRY

(71) Applicant: Primetals Technologies Austria GmbH, Linz (AT)

(72) Inventors: Gerald HOHENBICHLER, Linz (AT); Benjamin KRADEL, Waldmohr (DE); Manuel SATTLER, Wels (AT); Sonja STRASSER, Garsten (AT)

(21) Appl. No.: 18/554,390

(22) PCT Filed: Mar. 23, 2022
(86) PCT No.: PCT/EP2022/057639

§ 371 Date: Oct. 6, 2023

(30) Foreign Application Priority Data
Apr. 9, 2021 (EP) 21167621.8

(51) Int. Cl. G05B 19/418

(52) U.S. Cl. CPC G05B 19/41835; G05B 2219/31449; G05B 2219/45234

(57) ABSTRACT

An optimization method in which a computer ascertains expected values (E1) for actual variables (I1) of a technical process based on values (R) for target variables (Z1) of the technical process that attain the values (R) as far as possible. From data records (D), the computer provisionally selects a number (n1) of records (D) in which the variables (I1) display a minimum distance from the values (E1). The computer then ascertains expected values (E2) for the actual variables (I2) based on the values (R) and the values (E1). From the provisionally selected data records (D), the computer selects a predetermined second number (n2) of data records (D) in which the variables (I1, I2) display a minimum distance from the values (E1, E2). The computer ascertains set values (S) for the variables (Z2) for a yet-to-be-executed cycle to attain variables (Z1) as close to possible to the values (R).

### TECHNICAL FIELD

The present invention takes as its starting-point an optimization method, executed by a computer, for the operation of a plant in the basic-materials industry, in particular a plant in the steel industry or aluminum industry, by means of which a technical process is executed cyclically, time and time again. The plant in the basic-materials industry may be, for instance, a steel mill or a rolling mill or a part of a steel mill or of a rolling mill.

The present invention takes as its starting-point, moreover, a computer program which comprises machine code which is capable of being processed by a computer, the processing of the machine code by the computer having the effect that the computer executes an optimization method of such a type.

The present invention takes as its starting-point, moreover, a computer that has been programmed with a computer program of such a type, so that in operation it executes an optimization method of such a type.

### PRIOR ART

The statistical and mathematical analysis of data in order to optimize the attaining of key goals in the course of processes is known from the paper entitled “Data Analytics for Manufacturing Systems—A Data-Driven Approach for Process Optimization” by Florian Ungermann et al., Proceedings 52nd CIRP Conference on Manufacturing Systems (2019), pages 369 to 374.

An optimization method, executed by a computer, for a plant by means of which a technical process is executed cyclically, time and time again, is known from the paper entitled “Adaptive generalized predictive control based on JITL technique” by Yasuki Kansha et al., Journal of Process Control 19 (2009), pages 1067 to 1072. In the course of the optimization method, by utilizing a model of the plant and of the technical process the computer ascertains, on the basis of specified reference values for target variables of the technical process, expected values for actual variables of the technical process, so that the target variables attain the reference values as far as possible. From a large number of data records known to the computer, which comprise—in each instance for a single cycle of the technical process—the target variables and the actual variables, the computer then selects, in accordance with a predetermined distance criterion, a number of data records in which the actual variables display a distance from the expected values that is as small as possible. On the basis of the selected data records, the computer ascertains set values for a cycle of the technical process that is yet to be executed, so that the target variables attain the reference values as far as possible. The computer outputs the ascertained set values to an operator or to a control device of the plant. The plant is a plant in the chemical industry.

From the paper entitled “Artificial Intelligence Services in Steel Production—On Premises and in the Cloud” by Sonja Strasser et al., AISTech 2020—Proceedings of the Iron and Steel Technology Conference (2019), pages 1936 to 1944, and from the paper entitled “A Hybrid Data-Based and Model-Based Approach to Process Monitoring and Control in Sheet Metal Forming” by Sravan Tatipala et al., Processes 2020, Volume 8, pages 89 to 99, procedures are known in order to ascertain, in automated manner, high-quality set values for the operation of a plant by means of which a technical process is executed cyclically, time and time again. These plants are plants in the steel industry or aluminum industry.

### SUMMARY OF THE INVENTION

The performance of cyclically-executed processes in the basic-materials industry—in particular of processes in the steel industry, for instance in iron smelting, in steel production, in the casting and rolling of metal, particularly steel or aluminum—is almost never invariable, despite supposedly identical process control. Considerable deviations may even occur from cycle to cycle. As a result, considerable deviations also often arise in connection with the attaining of key targets (KPI=Key Performance Targets or Key Performance Indicators). Typical examples of such key targets are the maximizing of productivity, the optimizing of the quality of the product produced, the minimizing of the process costs, the minimizing of the energy demand per unit (for instance, per metric ton of material), and many more. Moreover, the performance is also very highly dependent on the mode of operation of the plant, for instance on the quantity and type of initial materials (for instance, in the case of steel production, on their chemical composition, and, in the case of rolling, on the initial dimensions and the temperature distribution), on the process control and also on the condition of the plant and the state of maintenance (for instance, wear and failed subcomponents of the plant).

In attempting process optimization, the expert and the process engineer must constantly pay attention to many parameters and influencing variables. Some of these influencing variables are opposing—that is to say, they bring about consequences opposed to one another. Such a multidimensionality of the optimization task may lead to a partial or complete overtaxing, even of an expert, so that often only a suboptimal operation of the plant in the basic-materials industry is achieved.

The object of the present invention consists in creating possibilities by means of which an optimal or at least almost optimal operation of the plant in the basic-materials industry can be achieved efficiently.

The object is achieved by an optimization method with the features of claim 1. Advantageous configurations of the optimization method are the subjects of dependent claims 2 to 6.

In accordance with the invention, an optimization method, executed by a computer, is created for the operation of a plant in the basic-materials industry, in particular a plant in the steel industry or aluminum industry, wherein a technical process is executed cyclically, time and time again, by means of the plant in the basic-materials industry. Within the scope of this optimization process, there is provision:
a) that by utilizing a model of the plant and of the technical process the computer ascertains, on the basis on specified reference values for first target variables of the technical process, first expected values for first actual variables of the technical process, so that the first target variables attain the reference values as far as possible,
b) that from a large number of data records known to the computer, which comprise—in each instance for a single cycle of the technical process—the first target variables and second target variables, the first actual variables and second actual variables, the computer provisionally selects, in accordance with a predetermined first distance criterion, a predetermined first number of data records in which the first actual variables display a distance from the first expected values that is as small as possible,
c) that the first target variables are disjunct from the second target variables, and the first actual variables are disjunct from the second actual variables,
d) that on the basis of the specified reference values for the first target variables and on the basis of the first expected values the computer ascertains second expected values for the second actual variables,
e) that from the provisionally selected data records the computer definitively selects a predetermined second number of data records in which the first actual variables and the second actual variables display, in accordance with a second distance criterion, a distance from the first and second expected values that is as small as possible,
f) that on the basis of the definitively selected data records for a cycle of the technical process that is yet to be executed the computer ascertains set values for the second target variables, so that the first target variables attain the reference values as far as possible, and
g) that the computer outputs the ascertained set values to an operator or to a control device of the plant in the basic-materials industry.

The plant in the basic-materials industry may be, as already mentioned, in particular a steel mill, a rolling mill or a part of such a plant.

In many cases, a batch process is executed by means of the plant in the basic-materials industry. In such cases, the term “cycle” is self-explanatory. But in some cases a continuous or quasi-continuous process is also executed by means of the plant in the basic-materials industry. In this case, the term “cycle”, to the extent that it relates to the past, is to be understood to mean any temporally contiguous interval for which a data record with the corresponding target variables and actual values is available. To the extent that this term relates to the future, it is to be understood to mean a temporally contiguous time-interval for which the reference values and set values are ascertained.

As a rule, thousands, tens of thousands, or even hundreds of thousands of data records of the described type are known to the computer. The data records are historical data records. They accordingly describe in each instance the manner in which the plant in the basic-materials industry was operated in the course of a particular cycle executed in the past. The data pool—that is to say, the totality of the data records—may be static or dynamic. If the data pool is dynamic, on the one hand new data records may be added to the data pool, and on the other hand old data records may drop out of the data pool.

Target variables of the technical process are those variables which are to be attained, as far as possible, in the course of the respective cycle of the technical process. If the plant is an arc furnace, and the technical process is therefore a melting operation for the melting of pig iron and/or scrap, together with subsequent refinement, for instance by decarburizing, the target variables may be, for instance, the electrical energy needed in the course of melting the pig iron or scrap, or the corresponding costs, the final temperature of the melt produced, the chemical composition of the melt produced, the process duration of the respective cycle, the wear arising in the respective cycle, and many more. It may be a question of directly capturable variables (one example: the temperature of the melt) or of derived variables (two examples: the quotient of the quantity of steel produced in one cycle divided by the time required for this, or the electrical energy needed per metric ton of steel produced).

The actual variables of the technical process may be of diverse nature. Actual variables may be, for instance, the status data of the plant by means of which the technical process is executed, initial materials, operating states, inclusive of the duration thereof or the start-time and/or end-time thereof, or the result of the technical process. If the plant is an arc furnace, and the technical process is therefore a melting operation for the melting of pig iron or scrap, together with subsequent refinement, for instance by decarburizing, the actual variables may be, for instance, the state of wear of the arc furnace (for instance, the thickness of the lining, or the electrode consumption), the quantity (for instance, in metric tons) and type of initial materials supplied to the arc furnace (pig iron, scrap, aggregates such as lime or dolomite, oxygen, etc.), the times or time-spans at or within which the various initial materials are supplied to the arc furnace, the temperature of the melt as a function of time, and the power required as a function of time. Further actual variables may be the actual variables corresponding to the target variables. A further possible actual variable may be the time of the last maintenance or inspection, or a comparable variable such as, for instance, the number of cycles executed since the last maintenance/inspection. In addition to these level-2 variables, the actual variables also include, at least partially, the temporal progressions of the level-1 variables—that is to say, the temporal progressions of the actual variables and/or manipulated variables of at least some of the regulators of the plant. In the case of an arc furnace, these regulators may be, for instance, the regulators for positioning of the electrodes, for the electrode voltage and for the electrode current. For a cycle of the technical process that has already been executed, the actual variables may also include the set variables. This is because the set variables were specified purely practically within the scope of this cycle which has already been executed. Simple example: actual value 1 of a data record=temporal progression of the actual value of the electrode position, and actual value 2 of the same data record=temporal progression of the set value of the electrode position.

It is possible that the data record also includes, moreover, correlations of target variables and/or actual variables with one another. In this case, the correlations can be ascertained by the computer. Appropriate procedures are generally known to persons skilled in the art. For instance, a person skilled in the art in the field of data analytics is familiar with so-called heat-maps and partial-dependence plots and also with trend analyses and trend graphs (known from data analytics and from process automation). Alternatively, it is possible that the correlations are ascertained in some other way and are jointly specified to the computer at the time of specification of the data records. Other correlations may also be ascertained where appropriate.

The first actual variables may comprise, as required, singular variables and temporal progressions of actual variables. As a rule, the first actual variables are level-2 variables. Accordingly, in the case of an arc furnace for instance, if the electrical energy needed per metric ton is specified as reference value for one of the first target variables, the first actual variables may be, or include, for instance, the final temperature of the melt or the set positioning of the electrodes as a function of time. On the other hand, as a rule it is not a question of level-1 variables—that is to say, for instance, the manipulated variables of process regulators.

The predetermined first number of data records may have been determined as required. This first number often lies within the double-digit or low to medium triple-digit range. For instance, the predetermined first number may be between 15 and 500. Values between 15 and 200 are preferred. The predetermined second number of data records is less than the first number of data records. This second number often lies within the medium to upper single-digit range, sometimes even within the low double-digit range. For instance, the predetermined second number may be between 5 and 20, in particular between 5 and 10.

The ascertainment of the smallest possible distance is generally known to persons skilled in the art. Reference may be made to the generally known algorithms and methods for the so-called nearest neighborhood.

It is possible that the second target variables are complementary to the first target variables, and/or that the second actual variables are complementary to the first actual variables. But this is not necessary. They only have to be disjunct from one another.

The term “expected value” is not meant in the sense as used in the field of statistics and probability calculus. With respect to the first expected values, the term is meant rather in the sense that the corresponding value has to be striven for or set, in order to be able to set the first target variables to the reference values. With respect to the second actual variables, it holds in analogous manner that the corresponding value has to be striven for or set, in order to be able to set the target variables to the reference values, and the first actual variables to the first expected values.

It is possible that the reference values have been permanently specified to the computer. However, the computer preferentially accepts the reference values from the operator. As a result, in particular a flexible mode of operation of the optimization process can take place.

In particular, there may be provision that the computer firstly accepts a selection of the first target variables as such from the operator, and only then accepts the reference values for the first target variables from the operator. As a result, the optimization process is capable of being employed very flexibly.

Between accepting the selection of the first target variables as such and accepting the reference values for the first target variables, the computer preferentially ascertains ranges of values, arising on the basis of the data records, for the first target variables, and outputs the ranges of values arising to the operator. As a result, the specification of “meaningful” reference values is alleviated for the operator.

Within the scope of the ascertainment of the ranges of values arising, it is possible that the computer does not output the complete ranges of values arising to the operator but disregards the largest and smallest values. For instance, the computer may exclude the largest 5% and/or the smallest 5% of values, or may output the complete ranges of values arising but may tag the largest 5% and/or the smallest 5% as such. Instead of the value of 5%, a different numerical value is, of course, also possible—for instance, 2%. It is also possible that the stated numerical value—for instance, 5% or 2%—is specified as such to the computer by the operator.

The computer preferentially outputs at least the first actual variables of the first number of data records to the operator and, by reason of specifications based on this output and provided by the operator, eliminates individual data records from the first number of data records, so that the eliminated data records are disregarded in the course of ascertaining the definitively selected data records. As a result, data records that the operator classifies as implausible or otherwise classifies as unsuitable by reason of his/her specialized knowledge can be eliminated, in particular in straightforward manner.

The optimization method has, moreover, preferentially been configured in such a manner that the computer executes steps b) to e) again after the first-time execution of step e). In this case, the computer bases the renewed execution of steps b) to e) upon the first actual variables, as first expected values, of that data record of the second number of data records which have displayed the smallest distance from the first expected values in the course of the execution of step e), which has already taken place. As a result, a still better optimization can take place.

The object is achieved, moreover, by a computer program with the features of claim 7. In accordance with the invention, the processing of the computer program has the effect that the computer executes an optimization method according to the invention.

The object is achieved, moreover, by a computer with the features of claim 8. In accordance with the invention, the computer has been programmed with a computer program according to the invention, so that in operation the computer executes an optimization method according to the invention.

### BRIEF DESCRIPTION OF THE DRAWINGS

The properties, features, and advantages of this invention, described above, and also the manner in which they are obtained, will become clearer and more clearly comprehensible in connection with the following description of the embodiment examples which will be elucidated in more detail in conjunction with the drawings. In these drawings, the following are shown, in schematic representation:

FIG. 1 a plant in the basic-materials industry, and associated components,

FIG. 2 a data record, and

FIGS. 3 to 5 flowcharts.

### DESCRIPTION OF THE EMBODIMENTS

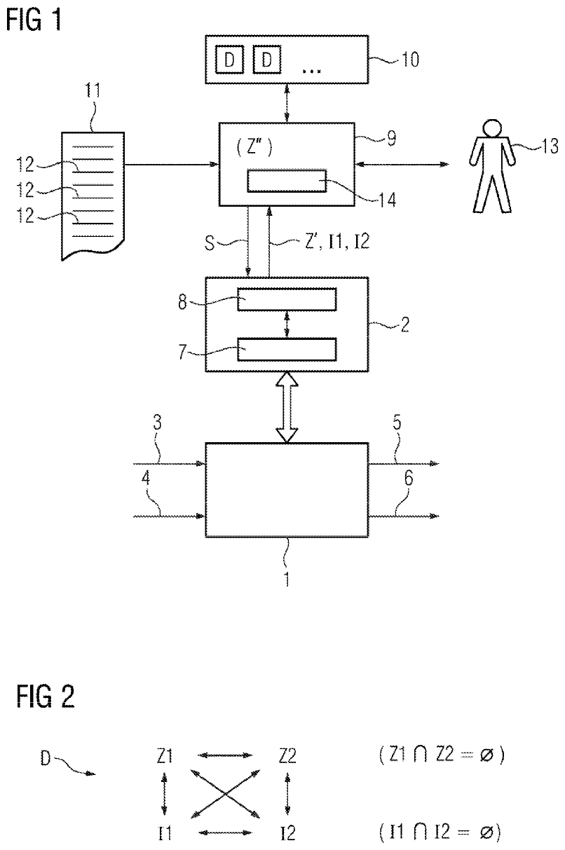

According to FIG. 1, a plant 1 in the basic-materials industry is controlled by a control device 2. Under control by the control device 2, a technical process is executed cyclically, time and time again, by means of the plant 1. Within the scope of a single cycle—that is to say, a self-contained one-time execution of the technical process—initial materials 3 and energy 4 are supplied to the plant 1, a (desired) primary product 5 is produced, and (undesirable) by-products 6 are often also produced. The supply of the initial materials 3 and of the energy 4 is often subject to temporal fluctuations. The same applies to the production of the primary product 5 and of the by-products 6.

The plant 1 is, as a rule, a plant in the steel industry, in some cases also in the aluminum industry. For instance, the plant 1 may take the form of a rolling mill in which new rolling stock (not represented) is rolled, time and time again. In this case, initial materials 3 may be, for instance, as yet unrolled rolling stock (=principal initial material) and water for cooling the rolling stock and possibly also for descaling the rolling stock. In this case, as a rule the energy 4 is substantially electrical energy. The desired primary product 5 is the rolled rolling stock. Undesirable by-products 6 may be, for instance, contaminated water and water vapor.

Similarly, the plant 1 may take the form, for instance, of an arc furnace in which a new batch of steel is produced, time and time again. In this case, initial materials 3 may be, for instance, pig iron, scrap, aggregates such as, for instance, lime or dolomite, and (within the scope of refining) oxygen. The initial materials 3 are supplied to the arc furnace at certain times or during certain periods of time. Energy 4 can be supplied to the arc furnace mainly in the form of electrical energy, but also in some cases through burning of fossilized raw materials. In the case of an arc furnace, the desired primary product 5 is the batch of steel. The batch is available only at the end of the process, but it is then also wholly available. Undesirable by-products 6 may be, in particular, waste gases and slags polluted with noxious substances.

The plant 1 may also take the form of a different plant in the steel industry or in the aluminum industry, for instance a continuous-casting plant or a combined casting/rolling plant.

The control device 2, which controls the plant 1, comprises, as a rule, several control levels. On the one hand, the control device 2 comprises, as a rule, process feedback controls 7 which perform control interventions in respect of the plant 1 in real time. The totality of the process feedback controls 7 is usually designated by persons skilled in the art as the level-1 system. In the case of an arc furnace, the operating voltage at which electrodes of the arc furnace are operated, and the position of electrodes, for instance, are regulated. In the case of a rolling mill, in particular the hydraulic adjustments of the roll stands, the rolling speeds, the tensions in the rolling stock, the exposure to coolant, and many more variables, are regulated. On the other hand, the control device 2 includes a higher-level technological process controller 8 by means of which, amongst other things, basic set values for the process feedback controls 7 are ascertained—that is to say, those set values with which the plant 1 would be operated in the case of fully trouble-free, ideal operation. The higher-level technological process controller 8 is usually designated by persons skilled in the art as the level-2 system.

The control device 2 is connected to a computer 9. Alternatively, the computer 9 may also have been combined with the control device 2 to form a common unit. The control device 2 communicates to the computer 9 a large number of different variables arising in a respective cycle of the technical process. The communicated variables comprise, on the one hand, target variables Z′ and, on the other hand, first and second actual variables I1, I2.

The target variables Z′ comprise the technological set values that are supplied to the technological process controller 8. The target variables Z′ establish which primary product 5 is to be produced by means of the plant 1 in the course of the respective execution of the technical process. The target variables Z′ are often time-independent, relative to the respective cycle. But sometimes they may also be time-dependent. In the case of a rolling mill, the technological set values may comprise, for instance, the dimensions of the rolled rolling stock, the temperature thereof after rolling (where appropriate, in the course of reeling), desired macromechanical or micromechanical properties, and such like. In the case of an arc furnace, the technological set values may comprise, for instance, the temperature and the chemical composition of the melt produced. The technological set values may, where appropriate, also include specifications for the undesirable by-products 6—for instance, limiting values to be adhered to by reason of statutory requirements.

On the basis of the technological set values and the description of the initial materials 3, the technological process controller 8 ascertains the basic set values for the process feedback controls 7. The first actual variables I1 may include, in particular, the basic set values for the process feedback controls 7 as such. The second actual variables I2 may include, for instance, the real actual values of the technical process—that is to say, the actual values arising in the plant 1 and supplied to the process feedback controls 7. Moreover, the second actual variables I2 may include the manipulated variables that are output to the plant 1 by the process feedback controls 7. Irrespective of a certain classification of a certain variable as first or second actual variable I1, I2, the first actual variables are, however, disjunct from the second actual variables I2. They may also be complementary to one another—that is to say, they may complement one another in their totality with respect to all captured actual variables. Moreover, both the first and the second actual variables I1, I2 may be time-dependent.

By utilizing the target variables Z′ and also the first and second actual variables I1, I2 and, where appropriate, further information, further target variables Z″ are ascertained. The further target variables Z″ may comprise, for instance, the electrical energy or total energy required to produce one metric ton of primary product 5, and/or the costs required to produce one metric ton of primary product 5. The totality of the first-mentioned target variables Z′ and of the further target variables Z″ will be designated generally below by the term target variables Z. The ascertainment of the further target variables Z″ can be—but does not have to be—executed by the computer 9.

If necessary, correlations of target variables Z and also actual variables I1, I2 with one another can also be ascertained by utilizing the target variables Z and also the first and second actual variables I1, I2 and, where appropriate, the further information. The ascertainment of the correlations can also be—but does not have to be—executed by the computer 9.

The correlations may be of local, temporal or other nature. A few simple examples of local and temporal correlations will be elucidated below.

In the case of a continuous-casting chill, a large number of temperature sensors have been distributed over the cold sides in a two-dimensional grid. The temperature sensors serve, in particular, to detect, in good time, an adhering part of the shell, with the resulting risk of a breach of the chill. In particular, local correlations of time/temperature curves that are recorded by means of temperature sensors arranged side by side, or temporally offset time/temperature curves that are recorded by means of temperature sensors arranged one below the other, may be relevant.

In the case of an arc furnace, there is often a temporal correlation between the temperature of the melt as a function of time and the energy input as a function of time.

In the case of a roll stand, there is often a correlation between the bending force, by means of which the working rollers of a four-high roll stand are pressed against the back-up rollers thereof, and the influence, brought about thereby, on the profile and planarity of the rolling stock.

The totality of target variables Z and of first and second actual variables I1, I2 of a respective cycle (more precisely: the respective values)—where appropriate, inclusive of the associated correlations—constitutes one data record D. A single data record D is represented by way of example in FIG. 2.

With each cycle of the technical process, a further data record D is obtained. In the course of time, a data pool 10 can thereby be formed which contains a large number of such data records D.

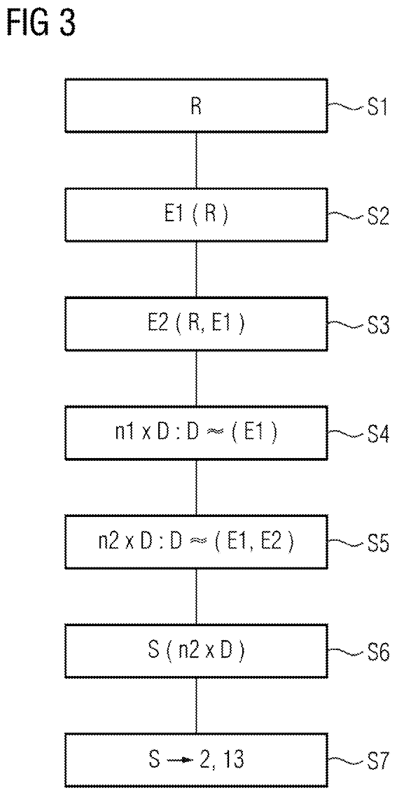

By means of the computer 9, an optimization method for the operation of the plant 1 is to be executed. For this purpose, the computer 9 has been programmed with a computer program 11. The computer program 11 comprises machine code 12 which is capable of being processed by the computer 9. The processing of the machine code 12 by the computer 9 has the effect that the computer 9 executes the corresponding optimization method. The optimization method will be elucidated in more detail below in conjunction with FIG. 3. In this connection, it is presupposed that the data pool 10 is already present—that is to say, it contains a large number of data records D. In this context, the term “large number” is not to be understood in the sense of “plurality”—that is to say, greater than 1. Rather, this term is to be understood in the sense of meaning far, far greater than 1. The data pool 10 contains at least hundreds of data records D. The data pool 10 often even contains thousands, tens of thousands or a still greater number of data records D. Moreover, the computer 9 has access to the data pool 10. Accordingly, the data records D are known to the computer.

According to FIG. 3, reference values R for first target variables Z1 of the technical process become known to the computer 9 in a step S1. For instance, the reference values R for the first target variables 21 may have been permanently specified to the computer 9. Often, however, they are specified to the computer 9 by an operator 13, corresponding to the representation in FIG. 1. The first target variables Z1 constitute a subset of the target variables Z. The first target variables 21 are the key objectives (KPI) that are to be achieved in the course of the operation of the plant 1. In the simplest case, only a single first target variable 21 is specified. But several first target variables (in this case, preferentially with their respective weighting) may also be specified.

In order to explain the difference between the terms “reference value” and “first target variable”, an example is provided below. But attention is drawn to the fact that this example is only an example and holds equally for other, analogous states of affairs. Let it be assumed, for instance, that a certain first target variable Z1 is the electrical energy needed to produce a certain quantity of steel. The corresponding first target variable Z1 as such then designates, irrespective of the concrete numerical value, the state of affairs “electrical energy needed to produce a certain quantity of steel”. The corresponding reference value R, on the other hand, designates the concrete numerical value, for instance “300 kWh/t”.

In a step S2, the computer 9 ascertains expected values E1 for the first actual variables I1 on the basis of the reference values R. The ascertainment also includes, where appropriate, times and periods of time for which the expected values E1 are valid. Accordingly, it is not necessarily a question of purely scalar values. Rather, it may also be a question of temporal progressions. The computer 9 accordingly ascertains the technological set values that are to be supplied to the technological process controller 8, insofar as they have not already been established by the reference values R. The expected values E1 will be designated below as first expected values E1, because they are determined for the first actual variables I1.

The ascertainment of the first expected values E1 is undertaken by utilizing a model 14 that describes the plant 1 and the technical process. The model 14 often describes the plant 1 and the technical process on the basis of equations of mathematical physics, these comprising equations algebraic and/or differential equations. But other models 14 are also conceivable, for instance based on artificial intelligence. However, irrespective of the type of the model 14, the ascertainment of the first expected values E1 is undertaken in such a manner that the first target variables 21 attain the reference values R as far as possible. If necessary, for the implementation of step S2 the computer 9 can formulate a cost function which the first target variables Z1 enter into. Where appropriate, boundary conditions can, in addition, also be taken into account. The establishing of cost functions and the optimization thereof, inclusive of the compliance with boundary conditions, are generally known to persons skilled in the art.

In a step S3, the computer 9 ascertains expected values E2 for the second actual variables I2. The computer 9 accordingly carries out a setup calculation, so to speak, for a planned cycle of the technical process, in which the reference values R are to be attained. The result of the setup calculation is the expected values E2. The ascertainment undertaken in step S3 also includes, if necessary, times and periods of time for which the expected values E2 are valid. The expected values E2 will be designated below as second expected values E2, because they are ascertained for the second actual variables I2. The ascertainment undertaken in step S3 is again undertaken by utilizing the model 14. The ascertainment is undertaken on the basis of the specified reference values R for the first target variables Z1 and on the basis of the first expected values E1 ascertained in step S2.

In a step S4, the computer 9 selects a predetermined first number n1 of data records D from the data pool 10. This selection is only provisional. In concrete terms, in step S4 the computer 9 firstly determines for the data records D, in accordance with a predetermined first distance criterion, a first distance of the respective data record D from the first expected values E1. Distance criteria are generally known to persons skilled in the art. Use may be made, in particular, of the “nearest neighborhood” method. Irrespective of the first distance criterion used in the concrete case, in step S4 the computer 9 then selects those data records D in which the first distance is as small as possible. Consequently a first limiting distance (according to the predetermined first distance criterion) results, and for all the provisionally selected data records D the respective associated first distance is at most as large as the first limiting distance, whereas for all the data records D not provisionally selected the respective associated first distance is at least as large as the first limiting distance.

With respect to steps S3 and S4, it may be noted, in addition, that they can also be executed in reverse order.

In a step S5, the computer 9 selects a predetermined second number n2 of data records D. This selection is definitive; it is restricted to those data records D which were provisionally selected in step S4. In concrete terms, in step S5 the computer 9 firstly determines for the provisionally selected data records D, in accordance with a predetermined second distance criterion, a second distance of the respective data record D from the first and second expected values E1, E2. Here too, distance criteria are generally known to persons skilled in the art. As previously, use may be made, in particular, of the “nearest neighborhood” method. Irrespective of the second distance criterion used in the concrete case, in step S5 the computer 9 then selects those data records D in which the second distance is as small as possible. Consequently a second limiting distance (according to the predetermined second distance criterion) results, and for all the definitively selected data records D the respective associated second distance is at most as large as the second limiting distance, whereas for all the data records D not definitively selected the respective associated second distance is at least as large as the second limiting distance.

In a step S6, the computer 9 ascertains set values S for second target variables 22. The set values S are intended for a cycle of the technical process that is yet to be executed. The ratio of the set values S to the second target variables Z2 is analogous to the ratio of the reference values R to the first target variables Z1. The second target variables Z2 are accordingly the target variables as such, irrespective of the concrete value, whereas the set values S are the corresponding concrete values. The computer 9 ascertains the set values S in step S6 on the basis of the definitively selected data records D. The ascertainment is undertaken in such a manner that the first target variables Z1 attain the reference values R as far as possible.

The second target variables 22 likewise constitute—analogously to the first target variables Z1—a subset of the target variables Z. They are disjunct from the first target variables Z1. As a rule, they are complemented by the first target variables Z1 to yield the target variables Z—that is to say, they are complementary to the first target variables Z1.

In a step S7, the computer 9 outputs the ascertained set values S. It is possible that the output is given to the operator 13. Alternatively or additionally, it is possible that the output is given to the control device 2, in particular to the technological process controller 8.

The optimization method according to the invention can be configured in various ways. Possible configurations will be elucidated below.

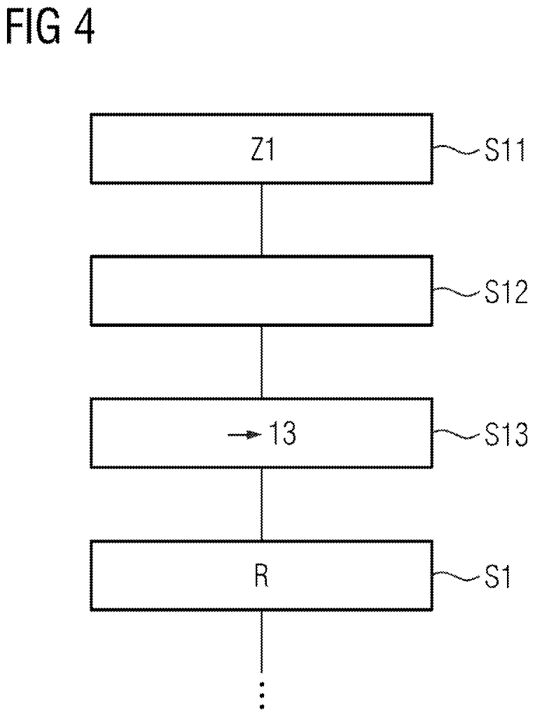

According to FIG. 4, the computer 9 executes steps S11 to S13 before step S1, step S12 being only optional. In step S11, the computer 9 accepts the first target variables Z1 as such from the operator 13. The operator 13 accordingly specifies to the computer 9 the first target variables Z1 for which the reference values R are to be determined. In the simplest case, the operator 13 selects only a single first target variable Z1. Alternatively, the operator 13 can also select several first target variables Z1. In this case, the operator 13 should additionally also indicate how the individual first target variables 21 are to be weighted. In step S12, the computer 9 ascertains ranges of values arising for the first target variables 21. This ascertainment is undertaken on the basis of the data records D. For instance, the minimum value and the maximum value can be ascertained for a respective first target variable Z1 specified in step S11. Variations are also useful, particularly when some of the largest and/or some of the smallest values arising are excluded in the course of ascertaining the range of values. In step S13, the computer 9 outputs the ranges of values arising to the operator 13.

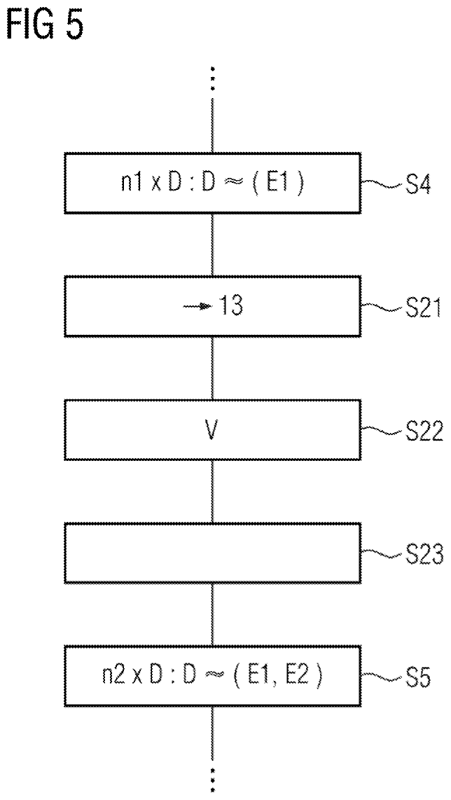

Alternatively or additionally, according to FIG. 5 the computer 9 can execute steps S21 to S23 between steps S4 and S5. In step S21, the computer 9 outputs at least the first actual variables I1 of the first number n1 of data records D to the operator 13. In step S22, the computer 9 accepts specifications V from the operator 13. The specifications V are based on the output of step S21. By reason of the specifications V, in step S23 the computer 9 eliminates individual data records D from the first number n1 of data records D. The eliminated data records D are disregarded in step S5 in the course of ascertaining the definitively selected data records D. Accordingly, the eliminated data records D are not included in the second number n2 of definitively selected data records D.

Moreover, it is possible that the computer 9 ascertains the set values S within the scope of a repeated iteration of the procedure according to the invention. For instance, the computer 9 can carry out a second and, where appropriate, also a third pass through steps S3 to S5. Within the scope of the second and, where appropriate, also the third processing of steps S3 and S4, the ascertainments therein can be based upon the first actual variables I1, as first expected values E1, of that data record D in which the first target variables 21 display the minimum distance from the reference values R. The computer 9 can also ascertain weighted or unweighted mean values of the first actual variables I1 of the second number n2 of definitively selected data records D, and can adopt these values as first expected values E1. As a result, an even more extensive optimization can be achieved—that is to say, for instance, a saving of additional costs or energy can be made, or the quality or the productivity can be maximized even further.

The present invention has many advantages. By reason of the utilization of extensive operating data pertaining to the plant 1, improved modes of operation compared to those in the prior art can be ascertained. By reason of the two-stage procedure in the course of ascertaining the data records D—that is to say, firstly utilizing only the first actual variables I1 for the purpose of ascertaining the first number n1 of data records D, and then utilizing also the second actual variables I2 for the purpose of ascertaining the second number n2 of data records D, the effort for the purpose of ascertaining those data records D on the basis of which the set values S are ascertained can be kept within reasonable limits. As a result, the technical process can be optimized more quickly and more sustainably than in the prior art. Already in the basic configuration according to FIG. 3, but in particular in the configuration according to FIG. 4, it is possible to react to changed requirements within a very short time.

Although the invention has been illustrated and described in detail by means of the preferred embodiment example, the invention is not restricted by the disclosed examples, and other variants may be derived therefrom by a person skilled in the art without departing from the scope of the invention.

### LIST OF REFERENCE SYMBOLS

1 plant
2 control device
3 initial materials
4 energy
5 primary product
6 by-products
7 process feedback controls
8 technological process controller
9 computer
10 data pool
11 computer program
12 machine code
13 operator
14 model
D data records
E1, E2 expected values
I1, I2 actual variables
n1, n2 numbers
R reference values
S set values
S1 to S23 steps
V specifications
Z, Z′, Z″, Z1, Z2 target variables

1. An optimization method, executed by a computer, for the operation of a plant in the basic-materials industry, in particular a plant in the steel industry or aluminum industry, by means of which a technical process is executed cyclically, time and time again,
a) wherein by utilizing a model of the plant and of the technical process the computer ascertains, on the basis of specified reference values (R) for first target variables (Z1) of the technical process, first expected values (E1) for first actual variables (I1) of the technical process, so that the first target variables (Z1) attain the reference values (R) as far as possible,
b) wherein from a large number of data records (D) known to the computer, which comprise—in each instance for a single cycle of the technical process—the first target variables (Z1) and second target variables (Z2), the first actual variables (I1) and second actual variables (I2), the computer provisionally selects, in accordance with a predetermined first distance criterion, a predetermined first number (n1) of data records (D) in which the first actual variables (I1) display a distance from the first expected values (E1) that is as small as possible,
c) wherein the first target variables (Z1) are disjunct from the second target variables (Z2), and the first actual variables (I1) are disjunct from the second actual variables (I2),
d) wherein on the basis of the specified reference values (R) for the first target variables (Z1) and on the basis of the first expected values (E1) the computer ascertains second expected values (E2) for the second actual variables (I2),
e) wherein from the provisionally selected data records (D) the computer definitively selects, in accordance with a predetermined second distance criterion, a predetermined second number (n2) of data records (D) in which the first actual variables (I1) and the second actual variables (I2) display a distance from the first and second expected values (E1, E2) that is as small as possible,
f) wherein on the basis of the definitively selected data records (D) for a cycle of the technical process that is yet to be executed the computer ascertains set values (S) for the second target variables (Z2), so that the first target variables (Z1) attain the reference values (R) as far as possible, and
g) wherein the computer-outputs the ascertained set values (S) to an operator or to a control device of the plant in the basic-materials industry.

2. The optimization method as claimed in claim 1, wherein the computer accepts the reference values (R) from the operator.

3. The optimization method as claimed in claim 2, wherein the computer firstly accepts a selection of the first target variables (Z1) as such from the operator and only then accepts the reference values (R) for the first target variables (Z1) from the operator.

4. The optimization method as claimed in claim 3, wherein between accepting the selection of the first target variables (Z1) as such and accepting the reference values (R) for the first target variables (Z1) the computer ascertains ranges of values, arising on the basis of the data records (D), for the first target variables (Z1), and outputs the ranges of values arising to the operator.

5. The optimization method as claimed in claim 1, wherein
the computer-outputs at least the first actual variables (I1) of the first number (n1) of data records (D) to the operator, and in that the computer-eliminates individual data records (D) from the first number (n1) of data records (D) on the basis of specifications, based on this output, provided by the operator, so that the eliminated data records (D) are disregarded in the course of ascertaining the definitively selected data records (D).

6. The optimization method as claimed in claim 1, wherein
the computer-executes steps b) to e) again after the first-time execution of step e), wherein the computer bases the renewed execution of steps b) to e) upon the first actual variables (I1), as first expected values (E1), of that data record (D) of the second number (n2) of data records (d) which have displayed the smallest distance from the first expected values (E1) in the course of the execution of step e), which has already taken place.

7. A computer program product comprising a non-transitory computer-readable medium having recorded thereon machine code which is capable of being processed by a computer, the processing of the machine code by the computer resulting in the execution of an optimization method as claimed in claim 1.

8. A computer programmed with a computer program to execute an optimization method as claimed in claim 1.
